(19) United States
(12) Patent Application Publication
(10) Pub. No.: US 2014/0132712 A1
(43) Pub. Date: May 15, 2014

(54) THREE-DIMENSION IMAGE FORMAT CONVERTER AND THREE-DIMENSION IMAGE FORMAT CONVERSION METHOD THEREOF

(71) Applicant: Realtek Semiconductor Corporation, Hsinchu (TW)

(72) Inventors: WenChi LIN, Yunlin County (TW); Ching-Sheng CHENG, Nantou County (TW); Tseng I. Lin, Kaohsiung City (TW); Chia-Wei YU, Taipei City (TW)

(21) Appl. No.: 13/935,227

(22) Filed: Jul. 3, 2013

(30) Foreign Application Priority Data
Nov. 13, 2012 (TW) 101142118

(51) Int. Cl. H04N 13/00

(52) U.S. Cl. CPC H04N 13/0029
USPC 348/43

(57) ABSTRACT

A three-dimension (3D) image format converter and a 3D image format conversion method thereof are provided. The 3D image format converter includes an input circuit, a processing circuit and an output circuit. The input circuit receives a frame packing signal carrying an image signal, a first vertical synchronization signal and a first data, enable signal. The processing circuit determines an active space of the image signal according to the frame packing signal, processes the first vertical synchronization to generate a second vertical synchronization signal, and processes the first data enable signal to generate a second data enable signal. The processing circuit generates a frame sequential signal carrying the image signal, the second vertical synchronization signal and the second data enable signal. The output circuit outputs the frame sequential signal.

This application claims the benefit of priority based on Taiwan Patent Application No. 101142118 filed on Nov. 13, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a three-dimension image format converter and a three-dimension image format conversion method thereof. More particularly, the three-dimension image format converter of the present invention can convert a frame packing signal into a frame sequential signal.

2. Descriptions of the Related Art

Over recent years, as the multimedia products become increasingly developed, the need for special effects of multimedia have also become ever higher. Accordingly, products related to three-dimension (3D) images have become a focus of attention.

The High Definition Multimedia Interface (HDMI) specification version 1.4 has defined a new 3D image format, i.e., the frame packing format. To display an image at a resolution of 1080p according to a frame packing signal complying with the frame packing format, a left-eye image signal and a right-eye image signal are transmitted at the same time, with a space signal that is interposed between the left-eye image signal and the right-eye image signal. However, because 3D image display devices currently available in the market usually support only a single 3D image format, 3D image display devices that support only a frame sequential format are unable to receive and process frame packing signals. In this case, the consumer must purchase a new 3D image display device that supports the frame packing format to receive and process the frame packing signals.

Accordingly, an urgent need exists in the art to provide a solution capable of converting a frame packing signal into a frame sequential signal and providing the converted frame sequential signal to a 3D image display device that supports only the frame sequential format.

### SUMMARY OF THE INVENTION

An objective of the present invention is to provide a three-dimension image format converter and a three-dimension image format conversion method thereof. The three-dimension image format converter of the present invention processes a vertical synchronization signal and a data enable signal of a frame packing signal according to an active space of the frame packing signal, and generates a vertical synchronization signal and a data enable signal conforming to the frame sequential format. In this way, when being installed at an input terminal of a three-dimension (3D) image display device that supports only a frame sequential format, the three-dimension image format converter of the present invention can convert a frame packing signal into a frame sequential signal and provide the frame sequential signal to the 3D image display device so that the 3D image display device can display the frame sequential signal. Thereby, the need for a consumer to purchase a new three-dimension image display device is eliminated.

To achieve the aforesaid objective, the present invention discloses a three-dimension image format converter. The three-dimension image format converter comprises an input circuit, a processing circuit and an output circuit. The input circuit is configured to receive a frame packing signal. The frame packing signal comprises an image signal, a first vertical synchronization signal and a first data enable signal. The processing circuit is coupled to the input circuit and configured to do the following: determine an active space of the image signal according to the frame packing signal, process the first vertical synchronization signal to generate a second vertical synchronization signal according to the active space, and process the first data enable signal to generate a second data enable signal according to the active space. The processing circuit generates a frame sequential signal. The frame sequential signal comprises the image signal, the second vertical synchronization signal and the second data enable signal. The output circuit is coupled to the processing circuit and configured to output the frame sequential signal.

Additionally, the present invention further discloses a three-dimension image format conversion method for a three-dimension image format converter. The three-dimension image format converter comprises an input circuit, a processing circuit and an output circuit. The processing circuit is coupled to the input circuit. The output circuit is coupled to the processing circuit. The three-dimension image format conversion method comprises the following steps: enabling the input circuit to receive a frame packing signal, which comprises an image signal, a first vertical synchronization signal and a first data enable signal; enabling the processing circuit to determine an active space of the image signal according to the frame packing signal, and process the first vertical synchronization signal and the first data enable signal to generate a second vertical synchronization signal and a second data enable signal, respectively, according to the active space; enabling the processing circuit to generate a frame sequential signal, which comprises the image signal, the second vertical synchronization signal and the second data enable signal; and enabling the output circuit to output the frame sequential signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a three-dimension image format converter 1 according to the first embodiment of the present invention;

FIG. 2 is a schematic view of a frame packing signal 102;

FIG. 3 is a schematic view of a frame sequential signal 104;

FIG. 4 is a schematic view of a processing circuit of a three-dimension image format converter 2 according to the second embodiment of the present invention;

FIG. 5 is a flowchart diagram of a three-dimension image format conversion method according to the third embodiment of the present invention; and

FIG. 6 is a flowchart diagram of a three-dimension image format conversion method according to the fourth embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, the description of these embodiments is only for purpose of illustration rather than to limit the present invention. It should be appreciated that in the following embodiments and the attached drawings, elements unrelated to the present invention are omitted from depiction.

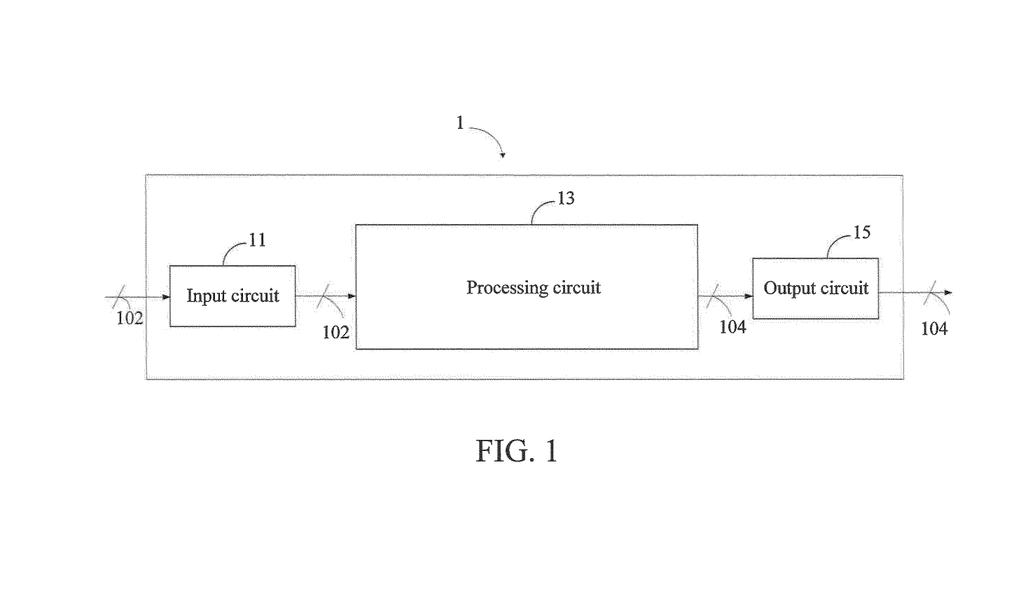

FIG. 1 is a schematic view of a three-dimension image format converter 1 according to the first embodiment of the present invention. The three-dimension image format converter 1 comprises an input circuit 11, a processing circuit 13 and an output circuit 15. The processing circuit 13 is coupled to the input circuit 11 and the output circuit 15. The three-dimension image format converter I may be installed at an input terminal of a three-dimension (3D) image display device (e.g., a liquid crystal screen, a liquid crystal television, a projector or the like) that supports only a frame sequential format to convert a frame packing signal into a frame sequential signal.

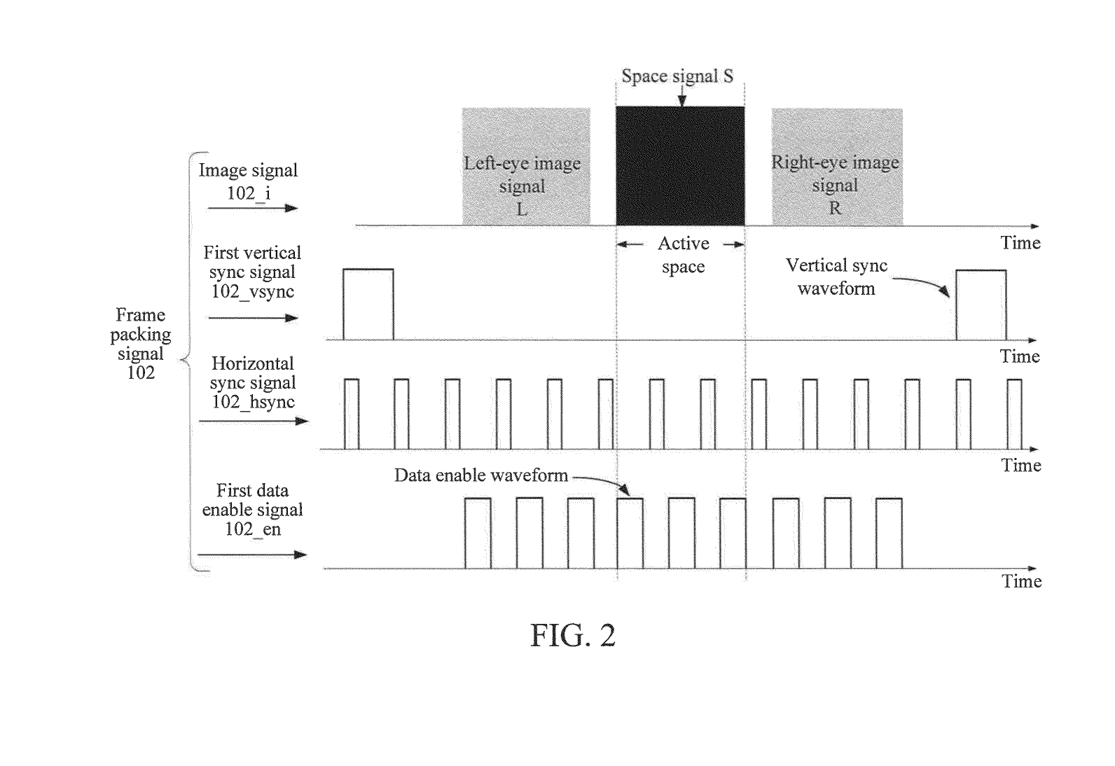

The input circuit 11 may comprise an input interface (e.g., a high definition multimedia interface (HDMI) interface) for receiving a frame packing signal 102 from an external multimedia player (not shown). As shown in FIG. 2, the frame packing signal 102 comprises an image signal 102_i, a first vertical synchronization signal 102_vsync, a horizontal synchronization signal 102_hsync and a first data enable signal 102_en. The image signal 102_i comprises a right-eye image signal R, a space signal S and a left-eye image signal L. The space signal S corresponds to an active space which is used to separate the right-eye image signal R and the left-eye image signal L from each other. The multimedia player may be a Bin-ray player, a personal computer or any other device that can generate a frame packing signal.

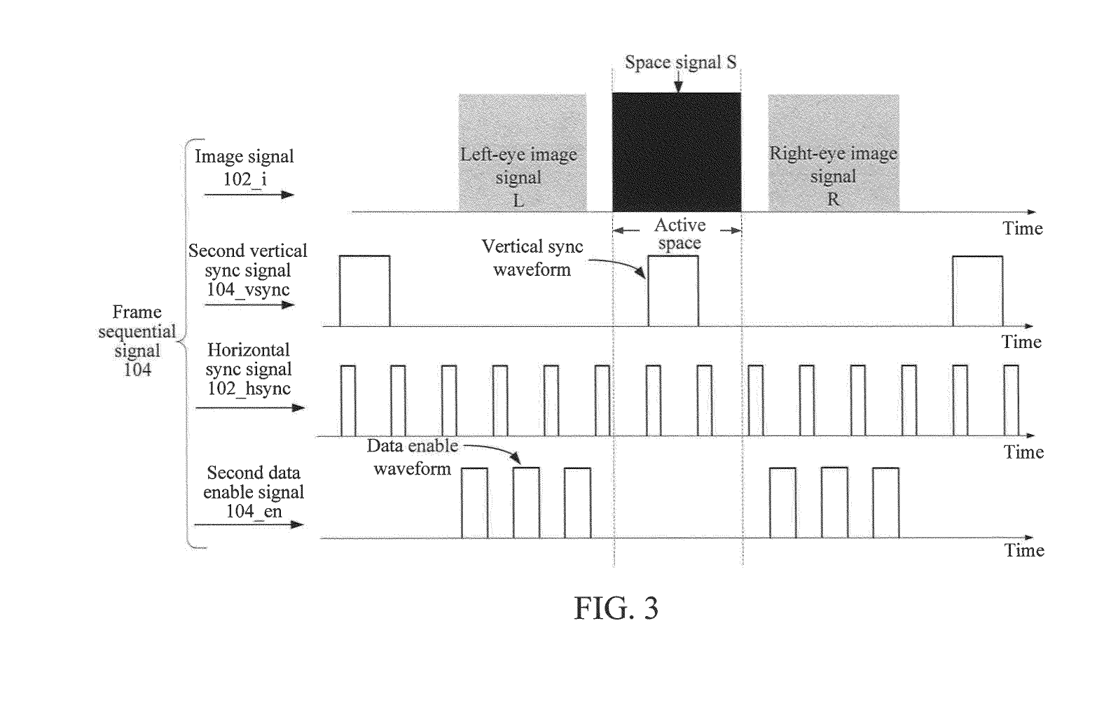

The processing circuit 13 determines the active space of the image signal 102_i according to the frame packing signal 102. Subsequently, the processing circuit 13 processes the first vertical synchronization signal 102_vsync to generate a second vertical synchronization signal 104_vsync according to the active space, and processes the first data enable signal 102_en to generate a second data enable signal 104_en according to the active space. Then, the processing circuit 13 generates a frame sequential signal 104, which comprises the image signal 102_1, the second vertical synchronization signal 104_vsync, the horizontal synchronization signal 102_hsync and the second data enable signal 104_en, as shown in FIG. 3. The output circuit 15 may comprise an output interface (e.g., an HDMI interface) and is configured to output the frame sequential signal 104 to the 3D image display device connected thereto.

In general, since the frame packing signal 102 contains information about the space signal of the image signal 102_i, and the space signal corresponds to the active space of the image signal 102_i, the processing circuit 13 receiving the frame packing signal 102 from the input circuit 11 can determine the active space of the image signal 102_i according to the information. Then, the processing circuit 13 erases the data enable waveform of a part of the first data enable signal 102_en that corresponds to the active space (i.e., converts the high-level voltages into low-level voltages) to generate the second data enable signal 104_en. Subsequently, the processing circuit 13 inserts a vertical synchronization waveform into a part of the first vertical synchronization signal 102_vsync that corresponds to the active space (i.e., converts low-level voltage into high-level voltage with a specific width) to generate the second vertical synchronization signal 104_vsync.

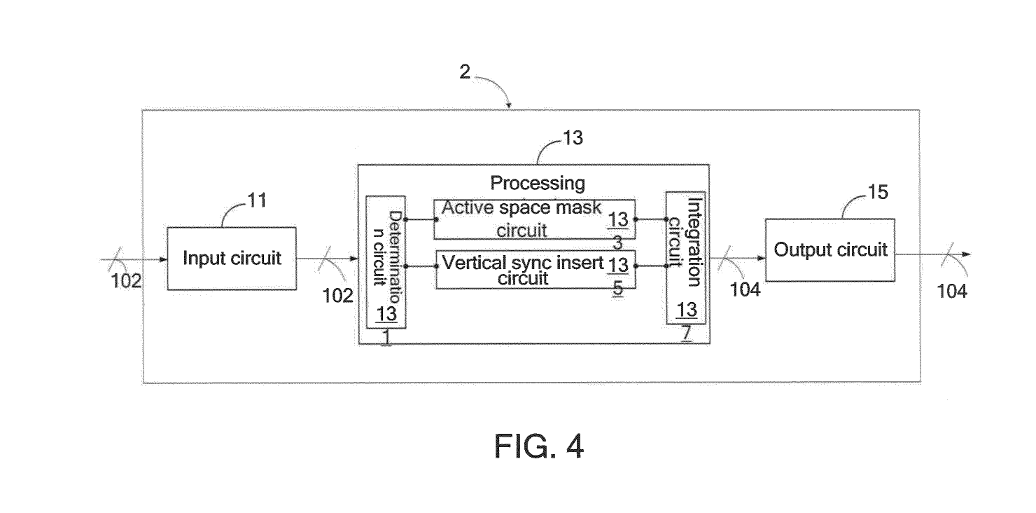

The second embodiment of the present invention is as shown in FIG. 4, which is a schematic view of a three-dimension image format converter 2. This embodiment differs from the first embodiment in that the processing circuit 13 comprises a determination circuit 131, an active space mask circuit 133, a vertical synchronization insert circuit 135 and an integration circuit 137. The determination circuit 131 and the integration circuit 137 are coupled to the active space mask circuit 133 and the vertical synchronization insert circuit 135. After the processing circuit 13 receives the frame packing signal 102 from the input circuit H, the determination circuit 131 determines the active space of the image signal 102_i according to the frame packing signal 102; the active space mask circuit 133 processes the first data enable signal 102_en of the frame packing signal 102; and the vertical synchronization insert circuit 135 processes the first vertical synchronization signal 102_vsync of the frame packing signal 102.

In particular, the active space mask circuit 133 is configured to erase the data enable waveform of the first data enable signal 102_en within the active space to generate the second data enable signal 104_en. The vertical synchronization insert circuit 135 is configured to insert the vertical synchronization waveform into the first vertical synchronization signal 102_vsync within the active space to generate the second vertical synchronization signal 104_vsync. Finally, the integration circuit 137 integrates the image signal 102_i, the second vertical synchronization signal 104_vsync, the horizontal synchronization signal 102_hsync and the second data enable signal 104_en to generate the frame sequential signal 104.

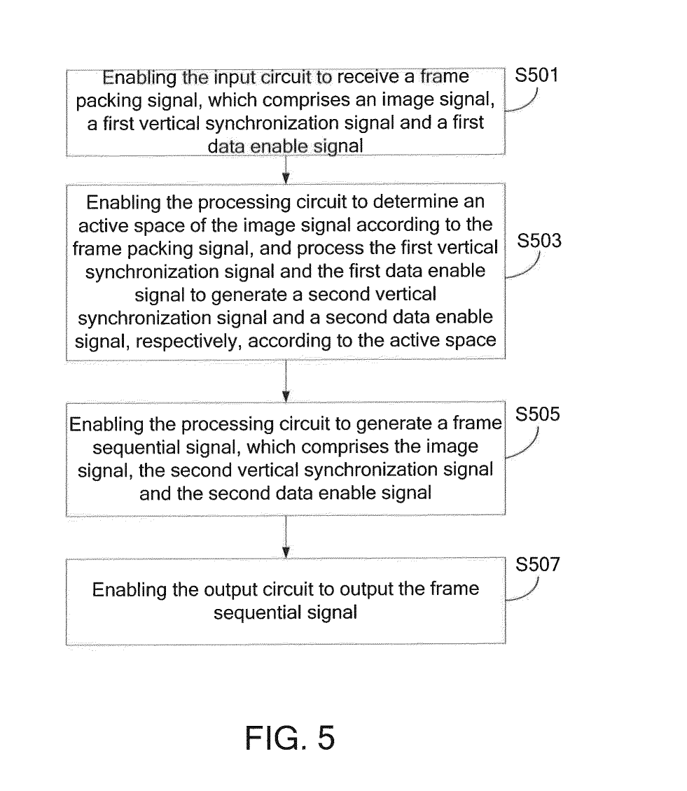

FIG. 5 is a flowchart diagram of a three-dimension image format conversion method according to the third embodiment of the present invention. The three-dimension image format conversion method of this embodiment can be used in a three-dimension image format converter (e.g., the three-dimension image format converter 1 of the first embodiment). The three-dimension image format converter comprises an input circuit, a processing circuit and an output circuit, and the processing circuit is coupled to the input circuit and the output circuit.

Firstly, step S501 is executed to enable the input circuit to receive a frame packing signal, which comprises an image signal, a first vertical synchronization signal and a first data enable signal. Subsequently, step S503 is executed to enable the processing circuit to determine an active space of the image signal according to the frame packing signal, and process the first vertical synchronization signal and the first data enable signal to generate a second vertical synchronization signal and a second data enable signal, respectively, according to the active space. Next, step S505 is executed to enable the processing circuit to generate a frame sequential signal, which comprises the image signal, the second vertical synchronization signal and the second data enable signal. Finally, step S507 is executed to enable the output circuit to output the frame sequential signal.

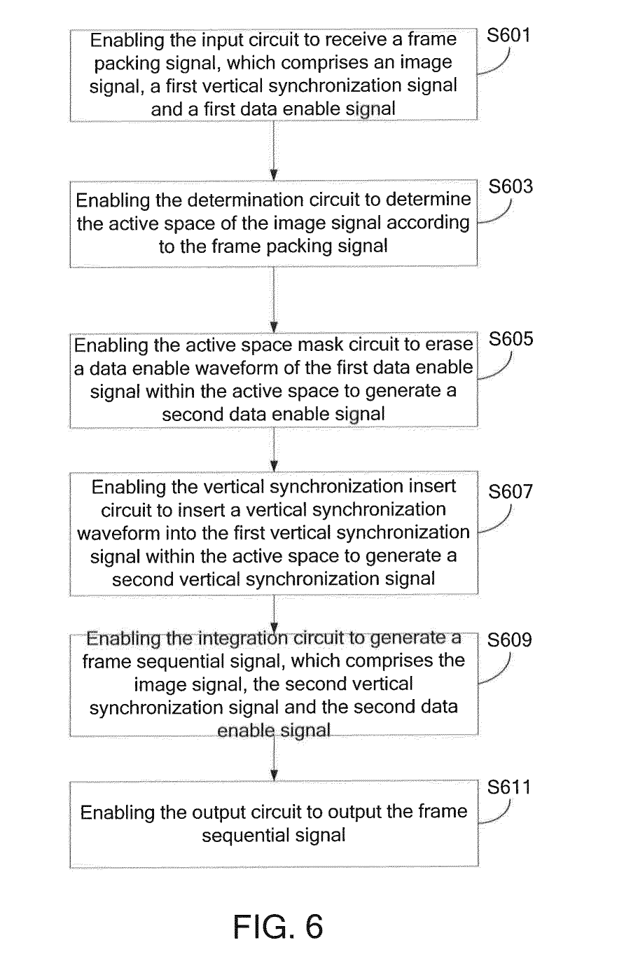

FIG. 6 is a flowchart diagram of a three-dimension image format conversion method according to the fourth embodiment of the present invention. The three-dimension image format conversion method of this embodiment can be used in a three-dimension image format converter (e.g., the three-dimension image format converter 2 of the second embodiment). The three-dimension image format converter comprises an input circuit, a processing circuit and an output circuit, and the processing circuit is coupled to the input circuit and the output circuit. In this embodiment, the processing circuit comprises a determination circuit, an active space mask circuit, a vertical synchronization insert circuit and an integration circuit, and the determination circuit and the integration circuit are coupled to the active space mask circuit and the vertical synchronization insert circuit.

First, step S601 is executed to enable the input circuit to receive a frame packing signal, which comprises an image signal, a first vertical synchronization signal and a first data enable signal. Subsequently, step S603 is executed to enable the determination circuit to determine the active space of the image signal according to the frame packing signal. Then, step S605 is executed to enable the active space mask circuit to erase a data enable waveform of the first data enable signal within the active space to generate a second data enable signal. Step S607 is executed to enable the vertical synchronization insert circuit to insert a vertical synchronization waveform into the first vertical synchronization signal within the active space to generate a second vertical synchronization signal. Then, step S609 is executed to enable the integration circuit to generate a frame sequential signal, which comprises the image signal, the second vertical synchronization signal and the second data enable signal. Finally, step S611 is executed to enable the output circuit to output the frame sequential signal.

According to the above descriptions, the three-dimension image format converter and the three-dimension image format conversion method thereof according to the present invention can easily and efficiently convert a frame packing signal into a frame sequential signal. Therefore, when being installed at an input terminal of a 3D image display device that supports only the frame sequential format, the three-dimension image format converter of the present invention can convert a frame packing signal into a frame sequential signal and provide the frame sequential signal to the 3D image display device so that the 3D image display device can display the frame sequential signal. Thereby, the need for a consumer to purchase a new three-dimension image display device is eliminated.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A three-dimension image format converter, comprising:
an input circuit, being configured to receive a frame packing signal carrying an image signal, a first vertical synchronization signal and a first data enable signal;
a processing circuit, being coupled to the input circuit and configured to determine an active space of the image signal according to the frame packing signal, process the first vertical synchronization signal to generate a second vertical synchronization signal according to the active space, process the first data enable signal to generate a second data enable signal according to the active space, and generate a frame sequential signal carrying the image signal, the second vertical synchronization signal and the second data enable signal; and
an output circuit, being coupled to the processing circuit and configured to output the frame sequential signal.

2. The three-dimension image format converter as claimed in claim 1, wherein the processing circuit further comprises:
a determination circuit, being configured to determine the active space of the image signal according to the frame packing signal;
an active space mask circuit, being coupled to the determination circuit and configured to erase a data enable waveform of the first data enable signal within the active space to generate the second data enable signal;
a vertical synchronization insert circuit, being coupled to the determination circuit and configured to insert a vertical synchronization waveform into the first vertical synchronization signal within the active space to generate the second vertical synchronization signal; and
an integration circuit, being coupled to the active space mask circuit and the vertical synchronization insert circuit and configured to generate the frame sequential signal.

3. The three-dimension image format converter as claimed in claim 1, wherein the image signal carries a right-eye image signal, a space signal and a left-eye image signal, and the space signal corresponds to the active space.

4. The three-dimension image format converter as claimed in claim 1, wherein the frame packing signal and the frame sequential signal each further comprise a horizontal synchronization signal.

5. The three-dimension image format converter as claimed in claim 1, wherein the input circuit comprises an input interface and the output circuit comprises an output interface.

6. The three-dimension image format converter as claimed in claim 5, wherein the input interface and the output interface are each a high definition multimedia interface (HDMI).

7. A three-dimension image format conversion method for a three-dimension image format converter, the three-dimension image format converter comprising an input circuit, a processing circuit and an output circuit, and the processing circuit being coupled to the input circuit and the output circuit, the three-dimension image format conversion method comprising the following steps:
enabling the input circuit to receive a frame packing signal carries an image signal, a first vertical synchronization signal and a first data enable signal;
enabling the processing circuit to determine an active space of the image signal according to the frame packing signal, and process the first vertical synchronization signal and the first data enable signal to generate a second vertical synchronization signal and a second data enable signal, respectively, according to the active space;
enabling the processing circuit to generate a frame sequential signal carrying the image signal, the second vertical synchronization signal and the second data enable signal; and
enabling the output circuit to output the frame sequential signal.

8. The three-dimension image format conversion method as claimed in claim 7, wherein the processing circuit further comprises a determination circuit, an active space mask circuit, a vertical synchronization insert circuit and an integration circuit, the determination circuit and the integration circuit are coupled to the active space mask circuit and the vertical synchronization insert circuit, and the three-dimension image format conversion method further comprises the following steps:
enabling the determination circuit to determine the active space of the image signal according to the frame packing signal;
enabling the active space mask circuit to erase a data enable waveform of the first data enable signal within the active space to generate the second data enable signal;
enabling the vertical synchronization insert circuit to insert a vertical synchronization waveform into the first vertical synchronization signal within the active space to generate the second vertical synchronization signal;
enabling the integration circuit to generate the frame sequential signal.

9. The three-dimension image format conversion method as claimed in claim 7, wherein the image signal carries a right-eye image signal, a space signal and a left-eye image signal, and the space signal corresponds to the active space.

10. The three-dimension image format conversion method as claimed in claim 7, wherein the frame packing signal and the frame sequential signal each further comprise a horizontal synchronization signal.
